(19) United States
(12) Patent Application Publication
(10) Pub. No.: US 2014/0150803 A1
(43) Pub. Date: Jun. 5, 2014

(54) MASSAGE TABLE ATTACHMENT APPARATUS

(71) Applicant: Jordan Gold, Aventura, FL (US)

(72) Inventor: Jordan Gold, Aventura, FL (US)

(21) Appl. No.: 13/705,272

(22) Filed: Dec. 5, 2012

(51) Int. Cl. A61G 99/00

(52) U.S. Cl. CPC A61G 99/00
USPC 128/845

(57) ABSTRACT

A conventional massage table combined with an attachment apparatus including body support straps to maintain a person being treated in a fixed position on the upper surface of the table. The attachment apparatus includes a belt sized to span across the width of the massage table upper surface and a removably attached anchor to engage and fix the spanning belt to the side rails of the table. A movably positioned body strap retainer is integrally formed with the anchors to position and retain the body support straps thereon to support the person being treated on the table.

### FIELD OF THE INVENTION

The present invention relates to a message table attachment apparatus and in particular to a conversion apparatus to hold a person on the message table during stretching manipulations.

### BACKGROUND OF THE INVENTION

In order to move efficiently and effortlessly in all ranges and planes of motion as well as perform athletic and similar physical movements, increased flexibility is an asset. This is particularly true as people age. Starting in their thirties and often even much younger, they become slowly and steadily less flexible with an impact on wellness and physical conditioning. Flexibility is lost at a rate of 1% a year whereby it does not take too many years before individuals begin to feel the effects of aging. This becomes a problem for individuals regularly using their athletic abilities, particularly those who perform at an elevated amateur or professional level.

In addition persons with a variety of physical disabilities often find stretching will increase range of movement thereby enhancing life style despite the disability issues.

In order to prevent the loss or decrease of flexibility, the concept of stretching before a physical or athletic endeavor such as playing ball, golfing, dancing and any number of similar physical activities is well known to the participants who engage in these events. Warm-up stretching is commonly done before an event. Also, stretching is incorporated into most serious training programs in order to gain maximum benefit for the performer. In addition to exercises that are done alone by a performer, a wide variety of stretching exercises are used when the performer seeks to work with individuals such as body workers, therapists, trainers and coaches as part of a training protocol. Stretching exercises and manipulations are performed with the aid of an assistant trained to maximize the individual's performance. Specifically, a trainer may move or push an individual's arm or leg to a stretched position to loosen muscle and fascia tissue. This application of force often requires the individual to be grounded or otherwise secured to a support surface to maintain the maximum stretch of a particular limb or body part being worked on without body movement.

Various types of straps and belts have been used to secure an individual to a table in order to maintain the individual in the same position during the stretching force application. A common practice is to wrap straps or belts under the table and around various body parts of the individual being stretched. For example if the legs are being stretched, a strap would likely be placed around the torso or hips of the individual in such a way to allow full movement of the legs while maintaining the torso in a relatively fixed position. Similarly if the individual's arms are to be stretched, it is likely a strap would be placed under the table and around the chest. Whereas these straps do provide some support, they usually are not secured and often move or slide during the application of the stretching force and thereby make the exercise more difficult to control.

The prior art also discloses tables with permanently attached straps that are fixed to the table sides and are designed to wrap over an individual lying on the table to secure the individual in an unmovable, fixed position. Being fixed, this arrangement is limited in adjustability since it does not fit all sizes of individuals who may need the stretching techniques. At best fixed straps require particular individuals to readjust their position with each stretching procedure.

Still another prior art structure for securing an individual in place on a table to facilitate a stretching procedure is formed of a strap having a clip or similar securing device on the end of the strap that is attached directly to the table. A shortcoming of this structure is the requirement of readjusting the location of the strap with each individual procedure and with different sized individuals receiving the work.

### SUMMARY OF THE INVENTION

The present invention is particularly adapted for use with the Stretch Zone Method that synthesizes controlled stretching techniques to work with the autonomic nervous system. This method quickly and efficiently improves muscle symmetry, enhances physical performance and mitigates rheumatic pain. The method recognizes the limiting factor to achieving full range of motion is not the length or elasticity of muscles but the nervous control of their tension via the stretch reflex. With precise stabilization, control and comfort, a practitioner systematically positions, stabilizes, isolates and carefully assists each rhythmical stretch. This proprietary method all takes place on innovative tables or tables converted using the present invention. The tables are purposefully designed and adorned with the necessary structure including adjustable belts, pads and straps allowing for the speedy extension of muscles further than the central nervous system would normally permit. As the practitioner continues in this systematic progression, the client's is gently guided past the active range of motion and back to zero tension before the muscle reacts to being stretched by going into further contraction.

Because the technique and the movement required, the practitioner needs a specifically designed massage table to effectively practice the method. Conventional massage tables do not provide the necessary structure needed. The present invention provides the necessary structure as an attachment apparatus for use with a conventional massage table, or similar type table that serves as a support for an individual in a prone, supine or side lying position lying on top of the table. The attachment apparatus serves to support and stabilize an individual in a fixed position on the massage table while undergoing a stretching application of force by a suitable trainer, body worker or physical therapist. The apparatus includes adjustably positioned body straps designed and sized to maintain and secure the person being treated on the massage table during the application of stretching forces on various body parts. The body straps are adjustably located on a strap support at the table edge that enables the body straps to move laterally along the length of the table edge to secure various sized individuals being treated. The strap support includes a unique positioning and anchoring apparatus integrally formed with the strap support to securely maintain the strap support on the table edge.

The strap support positioning and anchoring apparatus is attached to the table and includes a removable, flexible or elastic belt that is fitted to the upper surface and sized to span the width of the table and permanently secured anchors on opposite ends of the belt for attachment to the edge of the table. The anchors are U-shaped and designed to be attached to opposite sides of the table onto the table side rail frame, preferably under the table out of possible contact with a practitioner conducting the stretching exercises.

The body strap supports are integrally formed with the side rail anchors and include a cylindrical strap bar attached to brackets at the ends of the anchors. The strap bar is offset from the base of the U-shaped anchors forming an opening between the strap bar and the base of the anchor. In a preferred embodiment, a body strap or belt is looped around the cylindrical strap bar in such a way that it extends over the top of the table where it may be secured to a selected body part of an individual to be treated lying prone, supine or side lying of the top of the table.

The length of the cylindrical strap bar permits the body strap wrapped around the bar to be adjustably moved along the length of the side bar in order to be precisely located across the selected body part of the individual undergoing the stretch treatment exercise.

It will be appreciated the body strap or belt attached to the strap bar may be relatively narrow or wider and include various cushioning structures depending upon the manner in which it is used to restrain the individual on the table.

It will also be appreciated that while the present invention discloses two body strap supports, additional supports may be provided. Similarly a single body strap support may be sufficient if the overall length of the body strap support is extended to span a substantial portion of the length of the table. In an embodiment with a single body strap support it will be appreciated that several straps or belts may be provided along the length of the support to insure maximum flexibility to accommodate various sized individuals.

An object of the present invention is the provision of a message table attachment apparatus to maintain a person being treated in a fixed position on a massage table.

Another object is the provision of a strap support attached to a table that allows supporting body straps to be adjustable to accommodate a wide variety of different sized individuals.

These and other objects may be understood with reference to the following drawings and descriptive specification.

### DESCRIPTION OF THE DRAWINGS

FIG. 1 is a perspective view of the attachment apparatus connected on top of a conventional type massage table (partially shown) in accordance with the present invention.

FIG. 2 is a side perspective view of a single body strap support member on a massage table without straps.

FIG. 3 is an angular perspective view of FIG. 2.

FIG. 4 is a view of the support member detached from a table.

FIG. 5 is a detailed perspective view of one end of the body strap support member.

FIG. 6 is a view of a detail of the apparatus showing the anchor and table side rail.

### DESCRIPTION OF THE PREFERRED EMBODIMENT

A preferred embodiment of a massage table attachment apparatus 10 in accordance with the present invention is illustrated in the drawings in which like numerals refer to the same parts in each figure. Preferably the attachment apparatus 10 is used in combination with a conventional massage table 12 shown in part including a padded support surface 14, legs 16 and side rails 18. The version of the massage table 12 shown in the drawings is formed in two sections, an upper body section 20 and a lower body section 22 such that the sections 20 and 22 of the table 12 may be folded together to facilitate carrying and storage.

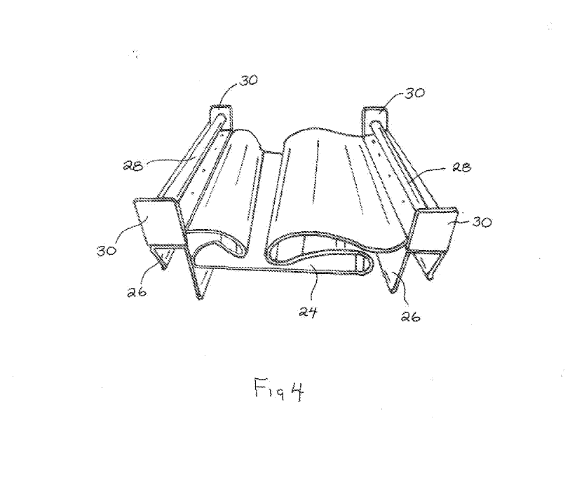

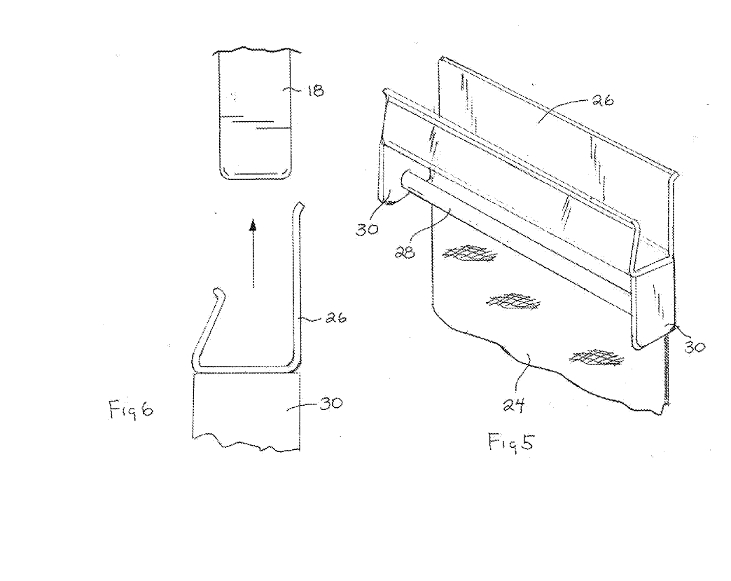

The attachment apparatus 10 converts a conventional massage table 12 to a table particularly useful for stretching procedures that typically require the application of stretching forces by a trainer or therapist to the person being treated while maintaining the person being treated in a fixed position on the table. The attachment apparatus 10 includes a wide flexible belt 24 that is sized to extend across the upper surface of the padded body support 14 thereby spanning the width of the table 12. Each end of the belt 24 is connected to an elongated, longitudinal, side rail anchor 26 approximately the same width as the belt 24 for attachment to the side rails 18 of the table 12. The ends of the belt 24 are attached to the side rail anchors 26 by suitable fasteners, not shown, or by epoxy type glue, heat welding or other suitable permanently attaching means. The side rail anchors 26 have a generally U-shaped cross section, as shown in the drawings, FIGS. 4, 5 and 6. Preferably the side rail anchors 26 are flexible in order to snap on the side rails 18 of the table 12; see FIG. 6. Alternately the anchors 26 may be rigid and sized to snugly fit over the side rails 18. The flexible spanning belt 24 exerts tension on the side rail anchors 26 to insure they remain in place during use.

The side rail anchors 26 are integrally formed with a body strap retainer 28 supported by a pair of brackets 30 that are formed with and extend from the side rail anchors 26. Preferably the body strap retainer 28 is a rigid cylindrical rod or tube having opposite ends attached to the brackets 30. In the preferred embodiment illustrated, the body strap retainer 28 is positioned directly under the side rail anchors 26 however the body strap retainer 28 may be angularly offset further under the table 12 and function equally as well.

Body support straps 32 are attached to the table 12 by being looped over the cylindrical body strap retainer 28 and extend across the table 12 to support a person lying thereon during a physical therapy or similar stretching session.

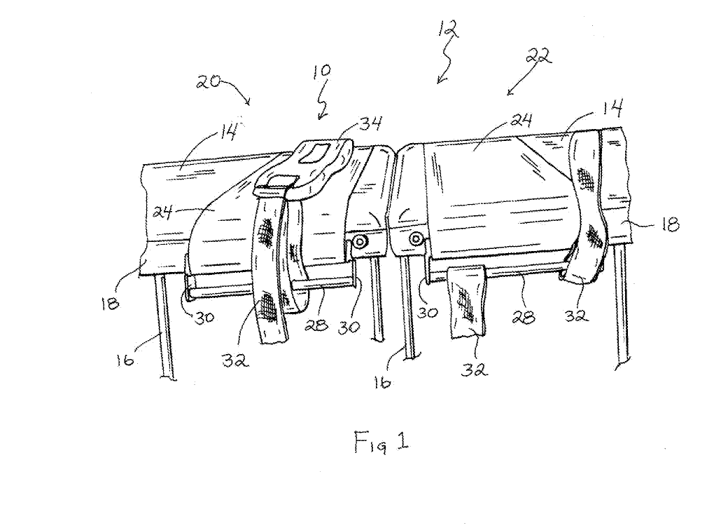

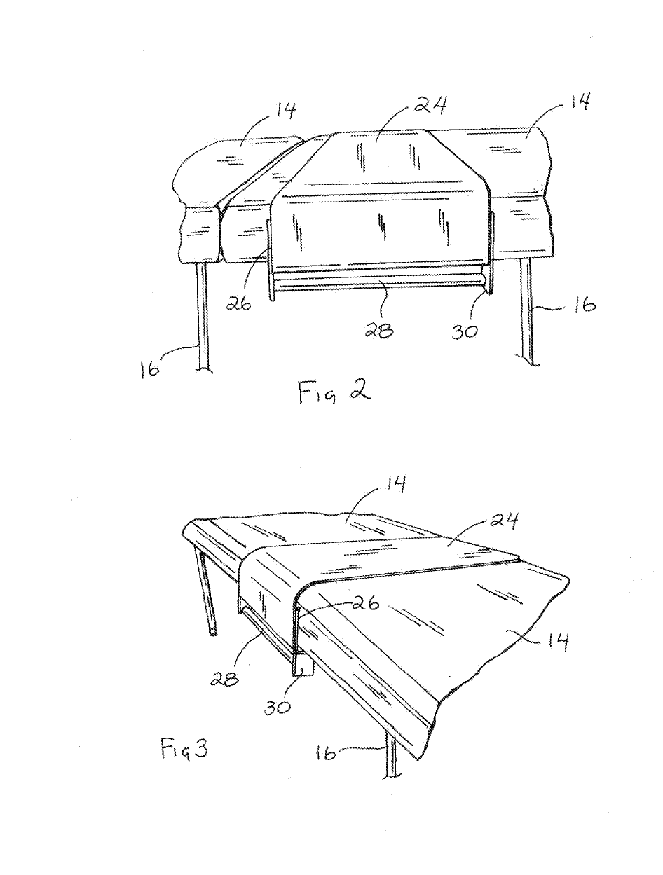

The body support straps 32 can be provided in a variety of widths and sizes. Referring to FIG. 1, a body support strap 32 designed to engage the torso or upper body of the person being worked on, is provided with a cushion 34 to more comfortably spread the retaining forces of the strap 32 against the body of the person on the table 12.

The width of the body support straps 32 is considerably less than the length of the cylindrical retainer 28 such that the straps 32 may be longitudinally positioned along the length of the retainer 28 in order that the straps 32 can be adjusted to the physical characteristics of the person being treated without the necessity of removing and repositioning the entire apparatus 10. This arrangement also permits a plurality of straps to be positioned on a single cylindrical retainer as shown on the retainer 28 on the section 24 of the table 12.

In use, the massage table attachment apparatus 10 of the present invention is attached to a massage table 12 by spreading the spanning belt 24 across the width of the upper surface 14 of the massage table 12. The open ends of the U-shaped, side rail anchors 26 are pushed over and snapped onto the downwardly extending side rails 18 of the table 12. Once the anchors 26 are frictionally attached to the side rails 18, there are maintained thereto by the tension of the belt 24. The body support straps 32 are adjustably positioned over the cylindrical retainer 28 by looping a strap 32 through the opening between the cylindrical retainer 28 and the bottom of the anchor 26. A person being treated lies on top of the table 12 and the body support straps 32 are secured to a selected body part to maintain the person on the table 12 in a fixed position during treatment. The exact position, the number of straps 32 used and location on the body of the person being treated are determined by the body work/stretching techniques or exercises that are particularly suited for the individual.

Whereas the apparatus has been shown as a specific size relative to the table, it will be appreciated that modifications of the attachment apparatus may be made. For example, the overall length of the apparatus may vary depending upon the intended use and may extend the entire length of the side of a massage table in order to accommodate a number of body support straps.

Other modifications may be made to the above described apparatus in keeping within the spirit and scope of the present invention, as defined in the following claims.

1. In combination with a table having an upper surface to support a person lying thereon, side rails and table support means, an attachment apparatus including body support straps to maintain the person in a fixed position on the upper surface of the table; comprising:
said attachment apparatus characterized by a spanning belt sized to span across the width of said table upper surface; said spanning strap member having a pair of longitudinal anchors attached thereto at opposite ends thereof for attachment of said belt to the table; said anchors being generally u-shaped to engage and fix said spanning strap to said side rails of said table; and, a body strap retainer integrally formed with said anchors to position and retain said body support straps thereon; said body strap retainer including a strap mount attached to brackets extending outwardly from said anchors.

2. The apparatus of claim 1 wherein said strap mount is a cylindrical rod.

3. The apparatus of claim 1 further including at least one body strap on said strap mount.

4. The apparatus of claim 3 wherein said strap mount is longer than said body strap whereby said body strap is adjustably movable along the length of said strap mount.

5. An apparatus for attachment to a massage table comprising:
a spanning belt sized to fit across the width of said table;
a pair of anchors attached to opposite ends of said spanning belt, said anchors structured to be removably attached to side rails of the massage table;
body strap retainers attached to each of said anchors;
and, at least one body strap movably positioned on said body strap retainer.

6. The apparatus of claim 5 wherein said spanning belt is formed of flexible material.

7. The apparatus of claim 5 wherein said anchor rails are U-shaped and sized to fit over and engage said massage table side rails.

8. The apparatus of claim 5 wherein said body strap retainers extend the length of said anchors.

9. The apparatus of claim 8 wherein said body strap retainers are cylindrical in shape and include mounting brackets integrally formed with and extending from said anchors.

10. The apparatus of claim 5 being further defined by a plurality of body straps.

11. The apparatus of claim 5 wherein said anchors and said body strap retainers are longitudinal in shape and are at least twice the size of said body strap.

12. The apparatus of claim 11 wherein said body strap is movable longitudinally along the length of said body strap retainers.
